(19) United States
(12) Patent Application Publication
(10) Pub. No.: US 2026/0120605 A1
(43) Pub. Date: Apr. 30, 2026

(54) DRIVING METHOD AND DEVICE FOR DISPLAY PANEL, STORAGE MEDIUM, AND DISPLAY APPARATUS

(71) Applicants: Chengdu BOE Optoelectronics Technology Co., Ltd., Chengdu, Sichuan (CN); BOE Technology Group Co., Ltd., Beijing (CN)

(72) Inventors: Bin WANG, Beijing (CN); Qiang XIE, Beijing (CN); Shiming LI, Beijing (CN); Tan JING, Beijing (CN); Guangrong LU, Beijing (CN)

(73) Assignees: Chengdu BOE Optoelectronics Technology Co., Ltd., Chengdu, Sichuan (CN); BOE Technology Group Co., Ltd., Beijing (CN)

(21) Appl. No.: 18/578,319

(22) PCT Filed: Jun. 29, 2022
(86) PCT No.: PCT/CN2022/102508

§ 371 Date: Jan. 11, 2024

(51) Int. Cl. G09G 3/20; G09G 3/3233

(52) U.S. Cl. CPC G09G 3/2007; G09G 3/3233; G09G 2320/0233

(57) ABSTRACT

A driving method for a display panel includes obtaining a grayscale value of each pixel point in an image to be displayed; determining a pixel point as a target pixel point in response to the grayscale value of the pixel point being less than a preset grayscale threshold; obtaining, based on a preset correspondence, a target grayscale value and a target display frequency that correspond to the target pixel point, where the target grayscale value is greater than the grayscale value of the target pixel point, and the target display frequency is less than or equal to a first design display frequency of the target pixel point; and displaying, based on the target grayscale value and the target display frequency, the target pixel point in the image.

### TECHNICAL FIELD

The present disclosure relates to the field of display technology, and specifically to a driving method and device for a display panel, a storage medium, and a display apparatus.

### BACKGROUND

An organic light emitting diode (OLED) is an active light emitting display device with the advantages of self-illumination, wide viewing angle, high contrast ratio, low power consumption, very high response speed, being thin and light, and being bendable. With the continuous development of display technology, the application of display devices using OLEDs as light emitting devices is becoming more and more widespread. In the related arts, there is a problem of an uneven display brightness in the OLED display screen.

It should be illustrated that the information disclosed in the above-described background section is only used for enhancing the understanding of the background of the present disclosure, and thus may include information that does not constitute prior art known to those ordinary skilled in the art.

### SUMMARY

An object of the present disclosure is to overcome the deficiencies of the prior art described above, and provide a driving method and device for a display panel, a storage medium, and a display apparatus.

According to an aspect of the present disclosure, a driving method for a display panel is provided. The method includes:
obtaining a grayscale value of each pixel point in an image to be displayed;
determining a pixel point as a target pixel point if the grayscale value of the pixel point is less than a preset grayscale threshold;
obtaining, based on a preset correspondence, a target grayscale value and a target display frequency that correspond to the target pixel point, where the target grayscale value is greater than the grayscale value of the target pixel point, and the target display frequency is less than or equal to a first design display frequency of the target pixel point; and
displaying, based on the target grayscale value and the target display frequency, the target pixel point in the image to be displayed.

In an exemplary embodiment of the present disclosure, the obtaining, based on the preset correspondence, the target grayscale value and the target display frequency that correspond to the target pixel point includes: determining, based on the preset correspondence, the target grayscale value and the target display frequency that correspond to the grayscale value of the target pixel point.

In an exemplary embodiment of the present disclosure, the method further includes:
determining a low grayscale range;
assigning a target grayscale value to each grayscale value within the low grayscale range;
determining. based on a first design display frequency of a pixel point with a grayscale value within the low grayscale range, a target display frequency corresponding to the target grayscale value; and
establishing the correspondence by associating the each grayscale value within the low grayscale range with the target grayscale value and the target display frequency that correspond to the grayscale value.

In an exemplary embodiment of the present disclosure, target grayscale values corresponding to respective ones of grayscale values within the low grayscale range are partially the same; or target grayscale values corresponding to respective ones of grayscale values within the low grayscale range are mutually different.

In an exemplary embodiment of the present disclosure, the display panel is provided with 256 grayscales, and the grayscale threshold is less than or equal to 8.

In an exemplary embodiment of the present disclosure, an absolute value of a difference between the grayscale value of the target pixel point and the target grayscale value corresponding to the target pixel point is greater than or equal to 4, and is less than or equal to 10.

In an exemplary embodiment of the present disclosure, the first design display frequency of the target pixel point is 2 to 4 times the target display frequency.

In an exemplary embodiment of the present disclosure, a display frequency of a pixel point, in the image to be displayed, with a grayscale value greater than the grayscale threshold is a second design display frequency. The first design display frequency of the target pixel point is the same as the second design display frequency, or the first design display frequency of the target pixel point is greater than the second design display frequency.

In an exemplary embodiment of the present disclosure, before the displaying, based on the target grayscale value and the target display frequency, the target pixel point in the image to be displayed, the method further includes determining, based on the target grayscale value, a grayscale voltage corresponding to the target grayscale value.

In an exemplary embodiment of the present disclosure, the displaying, based on the target grayscale value and the target display frequency, the target pixel point in the image to be displayed includes displaying, according to the target display frequency, the target pixel point in the image to be displayed by using the grayscale voltage corresponding to the target grayscale value.

In an exemplary embodiment of the present disclosure, the method further includes: determining a grayscale voltage of each pixel point, in the image to be displayed, with a grayscale value greater than the grayscale threshold; and displaying, according to the second design display frequency, the pixel point, in the image to be displayed, with the grayscale value greater than the grayscale threshold by using the grayscale voltage of the each pixel point.

In an exemplary embodiment of the present disclosure, the first design display frequency of the target pixel point is greater than or equal to 120 Hz.

In an exemplary embodiment of the present disclosure, the grayscale voltage of the target grayscale value is greater than a grayscale voltage of a low grayscale value corresponding to the target grayscale value.

According to a second aspect of the present disclosure, a driving device for a display panel is provided. The device includes:
a first obtaining module, configured to obtain a grayscale value of each pixel point in an image to be displayed;
a determining module, configured to determine a pixel point as a target pixel point if the grayscale value of the pixel point is less than a preset grayscale threshold;
a second obtaining module, configured to obtain, based on a preset correspondence, a target grayscale value and a target display frequency that correspond to the target pixel point, where the target grayscale value is greater than the grayscale value of the target pixel point, and the target display frequency is less than a first design display frequency of the display panel; and
a display module, configured to display, based on the target grayscale value and the target display frequency, the target pixel point in the image to be displayed.

According to a third aspect of the present disclosure, a computer-readable storage medium is provided. The computer-readable storage medium stores a computer program. The program, when executed by a processor, implements the driving method for the display panel described in any embodiment of the present disclosure.

According to a fourth aspect of the present disclosure, a display apparatus is provided. The display apparatus includes a display panel, one or more processors and a storage device. The storage device is configured to store one or more programs. The one or more programs, when executed by the one or more processors, enables the one or more processors to implement the driving method for the display panel described in any embodiment of the present disclosure.

It should be understood that the above general description and the later detailed description are exemplary and explanatory only and do not limit the present disclosure.

### BRIEF DESCRIPTION OF THE DRAWINGS

The accompanying drawings herein are incorporated into and form a part of the specification, illustrate embodiments consistent with the present disclosure, and are used in conjunction with the specification to explain the principles of the present disclosure. Obviously, the accompanying drawings in the following description are only some of the embodiments of the present disclosure, and other accompanying drawings may be obtained from these drawings by those ordinary skilled in the art without creative labor.

FIG. 1 is a flowchart of a driving method for a display panel according to an embodiment of the present disclosure.

FIG. 2 is a schematic diagram of a display adjustment according to an embodiment of the present disclosure.

FIG. 3 is a display diagram of a low grayscale image using a conventional driving method in the related art.

FIG. 4 is a display diagram of a low grayscale image using a driving method of the present disclosure.

FIG. 5 is a structural block diagram of a driving device for a display panel according to an embodiment of the present disclosure.

FIG. 6 is a schematic structural diagram of a display apparatus according to an embodiment of the present disclosure.

### DETAILED DESCRIPTION

Example embodiments are now described more comprehensively with reference to the accompanying drawings. However, the example embodiments are capable of being implemented in a variety of forms and should not be construed as being limited to the embodiments set forth herein. Rather, the provision of these embodiments allows the present disclosure to be comprehensive and complete and conveys the idea of the example embodiments comprehensively to those skilled in the art. The same reference numerals in the drawings indicate the same or similar structures, therefore their detailed descriptions will be omitted. In addition, the accompanying drawings are only illustrative illustrations of the present disclosure and are not necessarily drawn to scale.

In the related art, the organic electroluminescent layer of the OLED device has different sensitivities at different grayscale voltages. The inventor found that the organic electroluminescent layer is more sensitive to the current at low grayscales, and the pixel points of different grayscales have different variation degrees in display brightness caused by the same amount of voltage variation, which results in uneven brightness display and poor display image quality in the OLED display panel. When the OLED panel is in low grayscales, the voltage value matched to the corresponding brightness is not accurate due to inaccurate Gamma debugging device and poor Gamma curve. The above two factors both cause the significant brightness variation in the OLED display panel at low grayscales due to voltage deviation, resulting in uneven display brightness and the appearance of “cloud spot” effects.

The following is a unified description of the terminology involved in the present disclosure as follows.

Grayscale: refers to the brightness level of the display screen. The variation in the brightness of the display screen is not continuous. The brightness of the display screen varies according to preset brightness levels. These brightness levels are the grayscales of the display screen.

Gamma: refers to the allocation mode of pre-allocating the grayscale brightness corresponding to the grayscale. The sensitivity of the human eye to the variation in the brightness of the displayed image is related to the brightness of the image, and the human eye is most sensitive to the variation in the brightness of the image when the image is at a low brightness. Currently, the display screen is provided with a total of 256 grayscales (0 to 255-grayscale), and each grayscale corresponds to a brightness, that is, the brightness of the display screen can only vary to the brightness corresponding to each grayscale. The brightness corresponding to each grayscale is also pre-specified. For example, if the maximum brightness of the display screen is 256 nits, it can be specified that each grayscale corresponds to 1 nit, and a linear allocation is performed from 0-grayscale to 255-grayscale, that is, 1˜256 nits correspond to 0˜255-grayscale respectively. It can also be specified that the 0-grayscale corresponds to 0.5 nits, 1 grayscale corresponds to 1 nit, i.e., 256 nits are allocated non-linearly to 0˜255-grayscale. This allocation mode that pre-specifies the brightness corresponding to each grayscale is called gamma.

Gamma2.2: refers to that the gamma parameter is 2.2, meaning that each grayscale of the display screen and the corresponding grayscale brightness satisfy the formula: (grayscale value/256)^{2.2}=brightness. The present disclosure only uses Gamma 2.2 as an example to exemplarily illustrate the correspondence between the brightness and the grayscale. A display screen that satisfies Gamma 2.2±0.2 is considered a qualified product, and the display screen at this time best meets the linear requirements of the human eye for brightness and grayscale variations.

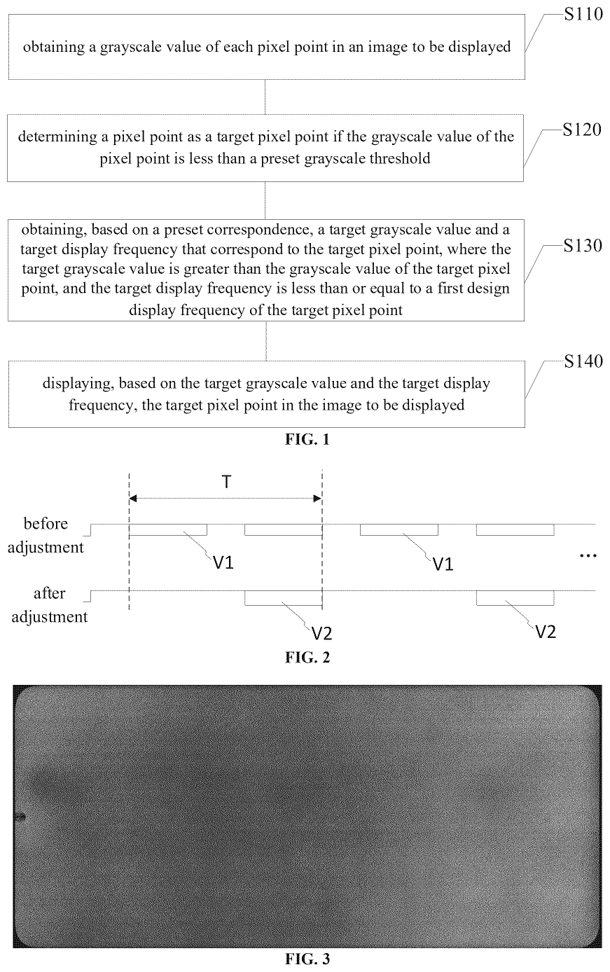

The display panel provided by the present disclosure improves the uneven display brightness of the display panel at low grayscales by changing the display driving method for low grayscales. FIG. 1 is a flowchart of a driving method for a display panel according to an embodiment of the present disclosure, and the display driving method can be applied to a display scene at a very low grayscale, e.g., for a grayscale display indicated by 0 to 255, a displayed image with a grayscale value of 1 to 8 can be driven to be displayed by using the driving method, and display uniformity at very low grayscales can be improved by the driving method. The method may be performed by a driving integrated circuit (DIC). As shown in FIG. 1, the method may include the following steps S110 to S140.

At step S110, a grayscale value of each pixel point in an image to be displayed is obtained.

At step S120, a pixel point is determined as a target pixel point if the grayscale value of the pixel point is less than a preset grayscale threshold.

At step S130, a target grayscale value and a target display frequency that correspond to the target pixel point are obtained based on a preset correspondence. Herein, the target grayscale value is greater than the grayscale value of the target pixel point, and the target display frequency is less than or equal to a first design display frequency of the target pixel point.

At step S140, the target pixel point in the image to be displayed is displayed based on the target grayscale value and the target display frequency.

In the driving method for the display panel provided by the present disclosure, the driving integrated circuit (DIC) compares the obtained grayscale value of the image to be displayed with the grayscale threshold, and if the grayscale value of the image to be displayed is less than the grayscale threshold, the image to be displayed of a low grayscale, and the driving integrated circuit (DIC) may determine the corresponding target grayscale value and target display frequency based on the preset correspondence, so as to display the low grayscale image to be displayed by using the target grayscale value and the target display frequency, thereby improving the uniformity of the low grayscale image and enhancing the display effect.

Hereinafter, the above steps of the present exemplary embodiment are described in greater detail.

In the step S110, the grayscale value of each pixel point in the image to be displayed is obtained.

The grayscale value has a correspondence with the display brightness, with a low grayscale having a low display brightness and a high grayscale having a high display brightness. For example, the display panel may be provided with 256 grayscales (0˜255-grayscale), and each grayscale corresponds to a brightness. The brightness corresponding to each grayscale is pre-specified. For example, if the maximum brightness of the display screen is 256 nits, it can be specified that each grayscale corresponds to 1 nit, and a linear allocation is performed from 0-grayscale to 255-grayscale, that is, 1˜256 nits correspond to 0˜255-grayscale respectively. Of course, in other embodiments, the grayscale value and the display brightness may have other correspondences, for example, 0-grayscale corresponds to 0.5 nits, 1-grayscale corresponds to 1 nit, and 256 nits are allocated non-linearly to 0˜255-grayscale, etc., which will not be described in detail herein.

The driving integrated circuit (DIC) may obtain the grayscale value of each pixel point of the image to be displayed through the motherboard connected to the DIC. After obtaining the grayscale value of each pixel point, the driving integrated circuit (DIC) may determine the grayscale voltage of the image to be displayed through the binding point voltage in the built-in Gamma module. Typically, when the analog power supply voltage provided by the integrated power supply circuit is used as a reference to set multi-path (n paths, such as 1024 paths) voltages through external resistors, the driving integrated circuit (DIC) is caused to generate 256 voltage values corresponding to each grayscale when receiving the multi-path voltages, the set n paths are called Gamma binding points, and these n-path voltages are called binding point voltages. After obtaining the grayscale value of the image to be displayed, the gamma module may determine the corresponding binding point voltage, that is, the gamma module may determine the corresponding gamma curve, and then the gamma module outputs the corresponding grayscale voltage.

As described above, when the OLED device is in low grayscale display, the uniformity of the display panel in low grayscale display is poor due to the improvement of the luminous efficiency of the OLED device. The present disclosure obtains the grayscale value of each pixel point of the image to be displayed, in order to filter out the low grayscale part of the image to be displayed in subsequent steps, and separately drive the pixel point of the low grayscale part to improve the display uniformity of the low grayscale image.

In the step S120, a pixel point is determined as the target pixel point if the grayscale value of the pixel point is less than the preset grayscale threshold.

The grayscale threshold may be determined based on the display uniformity of the displayed image. For example, the uniformity of the display brightness of the display panel may be evaluated by using the MCPD index to determine the grayscale threshold. Of course, other methods may also be used to evaluate the uniformity of the display panel, which will not be described in detail herein. The grayscale threshold may be pre-stored in the driving integrated circuit (DIC). When the grayscale value of the image to be displayed is less than the grayscale threshold, the image to be displayed may have the problem of uneven display of the image. The present disclosure solves the problem of uneven display of the low grayscale image by determining the pixel point less than the grayscale threshold as the target pixel point, and then by using the driving method, for the target pixel point, that is different from that for the pixel point with a normal grayscale value (the pixel point with a grayscale value larger than the grayscale threshold) in the subsequent step.

It should be understood that after the driving integrated circuit (DIC) obtains the grayscale value of each pixel point in the image to be displayed, the driving integrated circuit (DIC) compares the grayscale value of each pixel point with the preset grayscale threshold, in order to filter out the pixel point with a grayscale value less than the grayscale threshold.

In an exemplary embodiment, the display panel uses a total of 256 grayscales from 0 to 255 for brightness adjustment, and the grayscale threshold may be less than or equal to 8, i.e., the pixel point, in the image to be displayed, with a grayscale value less than or equal to 8 is determined as the target pixel point. In other words, the driving integrated circuit (DIC) operates the driving display method of the present disclosure on the image to be displayed with a grayscale value less than or equal to 8.

In the step S130, the target grayscale value and the target display frequency that correspond to the target pixel point are obtained based on the preset correspondence.

In the preset correspondence, each low grayscale value corresponds to a target grayscale value and a target display frequency. The correspondence may be stored in the line buffer of the driving integrated circuit (DIC), for example, by way of a table. After obtaining the grayscale value of the target pixel point in the image that is to be displayed currently, the driving integrated circuit (DIC) may obtain the target grayscale value and the target display frequency that correspond to the target pixel point by looking up the table.

In an exemplary embodiment, the correspondence may be pre-established in the driving integrated circuit (DIC) before the step S130, so as to perform grayscale conversion, through the correspondence, on the low grayscale pixel point of the image to be displayed and display the low grayscale pixel point. Exemplarily, pre-establishing the correspondence may include the following steps S101 to S104.

At step S101, a low grayscale range is determined.

At step S102, a target grayscale value is assigned to each grayscale value within the low grayscale range.

At step S103, a target display frequency corresponding to the target grayscale value is determined based on a first design display frequency of a pixel point with a grayscale value within the low grayscale range.

At step S104, the correspondence is established by associating each grayscale value within the low grayscale range with the target grayscale value and the target display frequency that correspond to the grayscale value.

The low grayscale range of uneven display brightness may be determined based on the uniformity evaluation index of the display panel at different grayscales. It is obvious that when the grayscale value of the image to be displayed is within the low grayscale range, the image to be displayed may be caused to have uneven display brightness.

After the low grayscale range is determined, a target grayscale value may be assigned to each grayscale value within the low grayscale range, in order to perform image display for the pixel point within the low grayscale range by using the target grayscale value in the subsequent step. Obviously, the target grayscale value needs to be larger than its corresponding grayscale value, so that the problem of uneven display brightness does not occur when the target grayscale value is used for display. For example, if the display panel uses a total of 256 grayscales from 0 to 255 for brightness adjustment, and the low grayscale value is 5, the target grayscale value corresponding to the low grayscale value may be 9, or 10, and so on. The present disclosure improves display uniformity by converting the low grayscale value to a relatively high grayscale value in order to display, through the high grayscale value according to the target display frequency, the low grayscale image that is to be displayed currently.

The display frequency may be understood as the scanning frequency of the display panel for the gate line. The higher the display frequency, the better the display effect. The first design display frequency is the display frequency of the display panel for the low grayscale (with a grayscale value less than the grayscale threshold) pixel point. Typically, the first design display frequency is the design frequency of the display panel, that is, the display frequency of the display panel for the low grayscale pixel point is the same as the display frequency of the display panel for the high grayscale pixel point. The target display frequency is the frequency of displaying the target pixel point according to the target grayscale value. The target display frequency may be less than or equal to the first design display frequency of the display panel for the low grayscale pixel point, and the driving integrated circuit (DIC) adjusts the display mode of the low grayscale image to be displayed in the subsequent step to be displaying according to the target grayscale value at the target display frequency by assigning to each grayscale value within the low grayscale range the target grayscale value that corresponds to the grayscale value, and by determining the target display frequency that corresponds to the target grayscale value, so that the display effect of the target pixel point after conversion is comparable to the display effect of displaying the target pixel point according to the first design display frequency before conversion to avoid causing visual differences of the user. For the process of driving the display after grayscale adjustment and display frequency adjustment for the low grayscale image, please refer to the introduction of the subsequent embodiments, and detailed description is not presented herein.

It should be noted that in the correspondence, the difference between the low grayscale value and its corresponding target grayscale value needs to be within a certain range to avoid new display problems caused by excessive brightness differences due to large grayscale spans, for example, excessive display brightness differences are easily perceived by the user. Exemplarily, the display panel uses a total of 256 grayscales from 0 to 255 for brightness adjustment, and the absolute value of the difference between the low grayscale value and its corresponding target grayscale value is greater than or equal to 4, and is less than or equal to 10. For example, in the preset correspondence, the target grayscale value corresponding to the grayscale value of 5 may be 9, 10, 11, 12, 13, 14, and the like. Exemplarily, Table 1 shows the correspondence between the low grayscale value and the target grayscale value in the correspondence.

TABLE 1

| low grayscale | target | target display frequency/ |
|---|---|---|
| value | grayscale value | actual display frequency |
| 8 | 12 | 1/4~1/2 |
| 7 | 11 | 1/4~1/2 |
| 6 | 10 | 1/4~1/2 |
| 5 | 9 | 1/4~1/2 |
| 4 | 9 | 1/4~1/2 |
| 3 | 9 | 1/4~1/2 |
| 2 | 9 | 1/4~1/2 |
| 1 | 9 | 1/4~1/2 |

As shown in Table 1, in an exemplary embodiment, the target grayscale values corresponding to different grayscale values within the low grayscale range may be partially the same. For example, the target grayscale values of grayscale values 1 to 5 in Table 1 are all 9, i.e., when the grayscale value of the low grayscale image to be displayed is 1 or 2 or 3 or 4 or 5, the driving integrated circuit (DIC) all adjusts the low grayscale image to be displayed to a grayscale value of 9 and performs display according to the target display frequency. Of course, as shown in Table 2, in some other embodiments, the target grayscale values corresponding to the low grayscale values within the low grayscale range may be mutually different. For example, in Table 2, each low grayscale value corresponds to a target grayscale value, and the target grayscale values corresponding to the low grayscale values are mutually different. This is not described in detail herein.

TABLE 2

| low grayscale | target | target display frequency/ |
|---|---|---|
| value | grayscale value | first design display frequency |
| 8 | 16 | 1/4~1/2 |
| 7 | 15 | 1/4~1/2 |
| 6 | 14 | 1/4~1/2 |
| 5 | 13 | 1/4~1/2 |
| 4 | 12 | 1/4~1/2 |
| 3 | 11 | 1/4~1/2 |
| 2 | 10 | 1/4~1/2 |
| 1 | 9 | 1/4~1/2 |

Furthermore, as shown in Table 1, in an exemplary embodiment, the first design display frequency of the display panel may be 2 to 4 times the target display frequency. For example, the first design display frequency may be 2 times, 2.5 times, 3 times, 3.5 times, 4 times, etc. the target display frequency. For example, the grayscale value of the low grayscale image to be displayed is 5, and the first design display frequency of the display panel is 240 Hz. After conversion through the correspondence, the target grayscale value may be 9, and the target display frequency may be 120 Hz. This is equivalent to using a grayscale voltage of 9-grayscale and reducing the display frequency of the 9-grayscale to 120 Hz to display the pixel point which is originally at the 5-grayscale brightness, in order to increase the grayscale value of the low grayscale image while reduce the display frequency of the low grayscale image, causing that the display brightness of the image to be displayed is comparable to the display brightness of the original low grayscale. Through the above methods, the grayscale value of the low grayscale image is increased, therefore, the display uniformity of the image to be displayed can be improved.

In the step S140, the driving integrated circuit (DIC) displays the target pixel point in the image to be displayed based on the target grayscale value and the target display frequency.

Generally, each grayscale value corresponds to a grayscale voltage. The higher the grayscale value, the larger its corresponding grayscale voltage, and correspondingly, the higher the display brightness. Obviously, the grayscale voltage of the target grayscale value needs to be larger than the grayscale voltage of the low grayscale value corresponding to the target grayscale value. The driving integrated circuit (DIC) displays the target pixel point in the image to be displayed based on the target grayscale value and the target display frequency, which can be understood as the driving integrated circuit (DIC) using the grayscale voltage corresponding to the target grayscale value to display the target pixel point in the image to be displayed according to the target display frequency.

The driving integrated circuit (DIC) may obtain the grayscale voltage corresponding to the current target grayscale value according to the built-in Gamma module of the DIC. As described above, the Gamma module stores the binding point voltage, the driving integrated circuit (DIC) may determine the target grayscale value according to the grayscale value of the image to be displayed, and the driving integrated circuit (DIC) may further call the corresponding binding point voltage according to the target grayscale value to obtain the corresponding grayscale voltage value.

The method of driving the target pixel point for display in the present step is further described below in connection with the accompanying drawings. Exemplarily, FIG. 2 is a schematic diagram of display adjustment according to an embodiment of the present disclosure, in which V1 indicates a grayscale voltage corresponding to a low grayscale value before adjustment, V2 indicates a grayscale voltage of a target grayscale value corresponding to the low grayscale value, V1 is smaller than V2, and T indicates a cycle. As shown in FIG. 2, the grayscale value of the image to be displayed is 5, and the first design display frequency of the display panel is 240 Hz. Based on the correspondence shown in Table 1, the driving integrated circuit (DIC) displays the image to be displayed according to the grayscale value of 9, and adjusts the display frequency of the image to be displayed to 120 Hz. If the grayscale voltage V1 of grayscale value 5 satisfies V1=2V and the grayscale voltage V2 of grayscale value 9 satisfies V2=3V, then in the step S140, the driving integrated circuit (DIC) is to adjust the display mode of the target pixel in the image to be displayed from displaying at original 2V grayscale voltage and according to 240 Hz to displaying at 3V grayscale voltage and according to 120 Hz. Obviously, because the 3V grayscale voltage is close to the 2V grayscale voltage, and the display frequency for the 3V grayscale voltage is reduced, the display brightness of displaying the target pixel point according to the driving method after adjustment can be similar to the display brightness of displaying the target pixel point according to the original driving method. And because the grayscale voltage is increased, it is equivalent to reducing the sensitivity to the target pixel point in the image to be displayed, thus improving the display uniformity of the image to be displayed at low grayscales.

Notably, in the present disclosure, the display frequency of the display panel for the pixel point with a low grayscale value less than or equal to the grayscale threshold is the first design display frequency, and the display frequency of the display panel for the pixel point with a grayscale value greater than the grayscale threshold is a second design display frequency. In some embodiments, the first design display frequency is the same as the second design display frequency. In other embodiments, the first design display frequency is different from the second design display frequency, and specifically, the first design display frequency may be greater than the second design display frequency, for example, the first design display frequency is 240 Hz, the second design display frequency is 120 Hz, and so on.

In addition, for the pixel point in the image to be displayed with a grayscale value greater than the grayscale threshold, the driving integrated circuit (DIC) may use the actual grayscale value of each pixel point to drive the display according to the second design display frequency of the display panel. For example, some pixel points in the image to be displayed have a grayscale value of 9 to 150, and the first design display frequency and the second design display frequency of the display panel are both 240 Hz, the driving integrated circuit (DIC) continues to perform display for these pixel points by using the grayscale voltage corresponding to the actual grayscale value of these pixel points and according to the display frequency of 240 Hz, i.e., the driving mode of these pixel points is not changed. Alternatively, the first design display frequency of the display panel is 240 Hz. and the second design display frequency of the display panel is 120 Hz, the driving integrated circuit (DIC) performs the display for the pixel points with a grayscale value of 9 to 150 and the pixel points with a grayscale value less than 9 by using the grayscale voltage corresponding to the actual grayscale value of these pixel points and according to the display frequency of 120 Hz.

The present disclosure uses a higher grayscale voltage to display the image to be displayed that is in low grayscales, i.e., increasing the grayscale voltage of the low grayscale image and reducing the display frequency after the adjustment of the grayscale voltage, that is, performing the display by using the higher grayscale voltage and according to a frequency lower than the original display frequency of the low grayscale, thus the problem of poor display uniformity at low grayscales can be solved while ensuring similar display brightness.

The effect improvement of the driving method of the present disclosure is further described below in connection with examples.

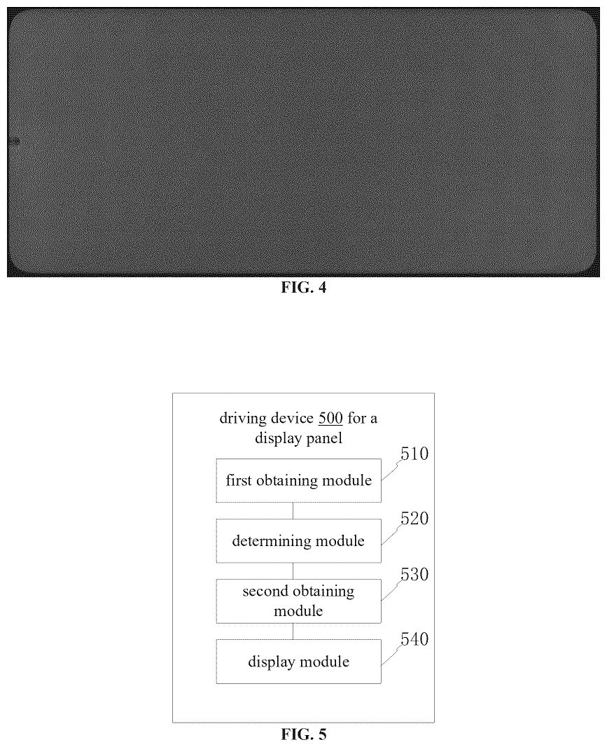

Exemplarily, FIG. 3 is a display diagram of a low grayscale image using a conventional driving method in the related art, and FIG. 4 is a display diagram of a low grayscale image using a driving method of the present disclosure. It can be seen that, compared to the conventional driving method, the uniformity of the low grayscale image in the driving method of the present disclosure can be greatly improved, and the driving method of the present disclosure has a better image quality display effect than the conventional driving method. Table 3 shows the color brightness uniformity detection results for the display image quality of FIG. 3, and Table 3 lists the 35-point color brightness uniformity calculation value difference for the displayed image of FIG. 3. Table 4 shows the color brightness uniformity detection results for the display image quality of FIG. 4, and Table 4 lists the 35-point color brightness uniformity calculation value difference for the displayed image of FIG. 4. The combination of Tables 3 and 4 shows that the color brightness uniformity calculation value difference ΔM of the displayed image of the conventional driving method is 22.895, and the color brightness uniformity calculation value difference ΔM of the displayed image of the driving method of the present disclosure is 16.879, and the color brightness uniformity of the displayed image is significantly improved. Of course, the uniformity of the displayed image can also be evaluated by the proportional relationship between the lowest color brightness uniformity calculation value and the highest color brightness uniformity calculation value, and the present disclosure does not limit the specific evaluation method.

TABLE 3

| | | | | | | | |
|---|---|---|---|---|---|---|---|
| color | 33.438 | 30.796 | 22.565 | 26.041 | 26.444 | 27.745 | 32.582 |
| brightness | 26.762 | 23.104 | 18.030 | 19.478 | 23.452 | 29.318 | 30.037 |
| uniformity | 19.357 | 22.401 | 16.114 | 18.186 | 24.879 | 30.708 | 31.317 |
| calculation | 24.742 | 21.350 | 19.389 | 22.235 | 27.976 | 33.253 | 34.333 |
| value M | 20.526 | 19.608 | 18.735 | 20.644 | 29.047 | 33.993 | 39.009 |

| | |
|---|---|
| M_MAX | 39.009 |
| M_MIN | 16.114 |
| Δ M | 22.895 |

TABLE 4

| | | | | | | | |
|---|---|---|---|---|---|---|---|
| color | 12.779 | 9.606 | 7.493 | 8.127 | 12.744 | 16.207 | 15.347 |
| brightness | 7.805 | 4.390 | 4.334 | 4.284 | 10.587 | 13.130 | 15.360 |
| uniformity | 8.371 | 5.185 | 4.338 | 6.386 | 11.347 | 14.825 | 17.724 |
| calculation | 7.385 | 5.536 | 5.144 | 8.995 | 15.912 | 19.041 | 18.990 |
| value M | 6.378 | 5.113 | 3.168 | 5.626 | 14.864 | 19.275 | 20.047 |

| | |
|---|---|
| M_MAX | 20.047 |
| M_MIN | 3.168 |
| Δ M | 16.879 |

The present disclosure also provides a driving device for a display panel. FIG. 5 is a structural block diagram of a driving device for a display panel according to an embodiment of the present disclosure. As shown in FIG. 5, the driving device 500) may include a first obtaining module 510, a determining module 520, a second obtaining module 530, and a display module 540.

The first obtaining module 510 is configured to obtain a grayscale value of each pixel point in an image to be displayed.

The determining module 520 is configured to determine a pixel point as a target pixel point if the grayscale value of the pixel point is less than a preset grayscale threshold.

The second obtaining module 530 is configured to obtain, based on a preset correspondence, a target grayscale value and a target display frequency that correspond to the target pixel point. Herein, the target grayscale value is greater than the grayscale value of the target pixel point, and the target display frequency is less than or equal to a first design display frequency of the target pixel point.

The display module 540 is configured to display, based on the target grayscale value and the target display frequency, the target pixel point in the image to be displayed.

In an exemplary embodiment, the second obtaining module 530 is further configured to determine, based on the preset correspondence, the target grayscale value and the target display frequency that correspond to the grayscale value of the target pixel point.

In an exemplary embodiment, the driving device 500 may further include a correspondence establishment module. The correspondence establishment module is configured to: determine a low grayscale range; assign a target grayscale value to each grayscale value within the low grayscale range; determine, based on a first design display frequency of a pixel point with a grayscale value within the low grayscale range, a target display frequency corresponding to the target grayscale value; and establish the correspondence by associating the each grayscale value within the low grayscale range with the target grayscale value and the target display frequency that correspond to the grayscale value.

In an exemplary embodiment, target grayscale values corresponding to respective ones of grayscale values within the low grayscale range are partially the same; or target grayscale values corresponding to respective ones of grayscale values within the low grayscale range are mutually different.

In an exemplary embodiment, the display panel is provided with 256 grayscales, and the grayscale threshold is less than or equal to 8.

In an exemplary embodiment, an absolute value of a difference between the grayscale value of the target pixel point and the target grayscale value corresponding to the target pixel point is greater than or equal to 4, and is less than or equal to 10.

In an exemplary embodiment, the first design display frequency of the target pixel point is 2 to 4 times the target display frequency.

In an exemplary embodiment, a display frequency of a pixel point, in the image to be displayed, with a grayscale value greater than the grayscale threshold is a second design display frequency. The first design display frequency of the target pixel point is the same as the second design display frequency, or the first design display frequency of the target pixel point is greater than the second design display frequency.

In an exemplary embodiment, the display module 540 is further configured to determine, based on the target grayscale value, a grayscale voltage corresponding to the target grayscale value before the displaying, based on the target grayscale value and the target display frequency, the target pixel point in the image to be displayed.

In an exemplary embodiment, the display module 540 is specifically configured to display, according to the target display frequency, the target pixel point in the image to be displayed by using the grayscale voltage corresponding to the target grayscale value.

In an exemplary embodiment, the display module 540 is further configured to: determine a grayscale voltage of each pixel point, in the image to be displayed, with a grayscale value greater than the grayscale threshold; and display, according to the second design display frequency, the pixel point, in the image to be displayed, with the grayscale value greater than the grayscale threshold by using the grayscale voltage of the each pixel point.

In an exemplary embodiment, the first design display frequency of the target pixel point is greater than or equal to 120 Hz.

In an exemplary embodiment, the grayscale voltage of the target grayscale value is greater than a grayscale voltage of a low grayscale value corresponding to the target grayscale value.

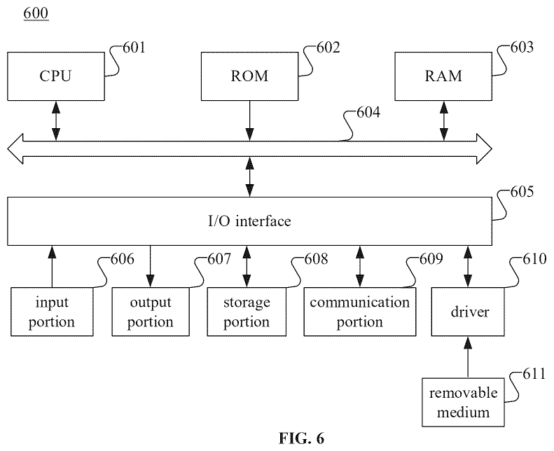

FIG. 6 is a schematic structural diagram of a display apparatus according to an embodiment of the present disclosure. It should be illustrated that the display apparatus 600 shown in FIG. 6 is only an example, and should not bring about any limitation on the functions and scope of use of the embodiments of the present disclosure. As shown in FIG. 6, the display apparatus 600 may be a variety of display apparatuses having a display screen, including but not limited to terminals, flat panels, and the like.

As shown in FIG. 6, the display apparatus 600 includes a central processing unit (CPU) 601, which may perform various appropriate actions and processing based on a program stored in a read-only memory (ROM) 602 or loaded from a storage portion 608 to a random access memory (RAM) 603. The RAM 603 also stores various programs and data necessary for the operation of the system. The CPU 601, ROM 602, and RAM 603 are connected to each other via a bus 604. The input/output (I/O) interface 605 is also connected to the bus 604.

The following components are connected to the I/O interface 605: an input portion 606 including a keyboard, a mouse, etc.; an output portion 607 including a cathode ray tube (CRT), a liquid crystal display (LCD) and a speaker, etc.; a storage portion 608 including a hard disk, etc.; and a communication portion 609 including a network interface card, such as a LAN card, a modem, etc. The communication portion 609 performs communication processing via a network such as the Internet. The driver 610 is also connected to the I/O interface 605 as needed. The removable medium 611, such as a disk, CD-ROM, magnetic disk, semiconductor memory, and the like, is installed to the driver 610 as needed so that computer programs read therefrom are installed into the storage portion 608 as needed.

In particular, according to the embodiments of the present disclosure, the process described above with reference to the flowchart in FIG. 1 may be implemented as a computer software program. For example, the embodiments of the present disclosure include a computer program product including a computer program carried on a computer-readable storage medium. The computer program includes program code used for performing the method shown in the flowchart. In such embodiments, the computer program may be downloaded and installed from a network via the communication portion 609, and/or installed from the removable medium 611. When this computer program is executed by the central processing unit (CPU) 601, various functions defined in the methods and devices of the present disclosure are performed.

It should be illustrated that the computer-readable storage medium shown in the present disclosure may be a computer-readable signal medium or a computer-readable storage medium or any combination thereof. The computer-readable storage medium may, for example, be, but is not limited to, a system, device, or apparatus that is electrical, magnetic, optical, electromagnetic, infrared, or semiconducting, or any combination of the above. More specific examples of the computer-readable storage medium may include, but are not limited to, an electrical connection having one or more wires, portable computer disk, hard disk, random access memory (RAM), read-only memory (ROM), erasable programmable read-only memory (EPROM or flash memory), optical fiber, portable compact disk read-only memory (CD-ROM), optical storage device, magnetic memory device, or any suitable combination of the above. In the present disclosure, the computer-readable storage medium may be any tangible medium containing or storing a program that may be used by or in combination with an instruction execution system, apparatus, or device. And in the present disclosure, the computer-readable signal medium may include a data signal propagated in a baseband or as part of a carrier, which carries computer-readable program code. Such propagated data signals may take a variety of forms, including, but not limited to, electromagnetic signals, optical signals, or any suitable combination of the above. The computer-readable signal medium may also be any computer-readable storage medium other than the computer-readable storage medium, and this computer-readable storage medium may send, propagate, or transmit a program for used by, or in combination with, an instruction execution system, apparatus, or device. The program code included in the computer-readable storage medium may be transmitted by using any suitable medium including, but not limited to, wireless, wired, optical fiber, etc., or any suitable combination of the above.

On the other hand, the present disclosure also provides a computer-readable storage medium. The computer-readable storage medium may be included in the display apparatus 600 described in the above embodiments, or may also exist separately without being assembled into the display apparatus 600. The above-mentioned computer-readable storage medium carries one or more programs. When one or more programs is executed by the display apparatus 600, the display apparatus 600 is enabled to implement the method as described in the above embodiments. For example, the display apparatus 600 may implement various steps as shown in FIG. 1.

After considering the specification and practicing the disclosure disclosed herein, those skilled in the art will easily come up with other embodiments of the present disclosure. The purpose of the present disclosure is to cover any variations, uses, or adaptive changes of the present disclosure, which follow the general principles of the present disclosure and include common knowledge or commonly used technical means in the technical field that are not disclosed in the present disclosure. The specification and embodiments are only considered exemplary, and the true scope and spirit of the present disclosure are indicated by the appending claims.

1. A driving method for a display panel, comprising:
obtaining a grayscale value of each pixel point in an image to be displayed;
determining a pixel point as a target pixel point in response to the grayscale value of the pixel point being less than a preset grayscale threshold;
obtaining, based on a preset correspondence, a target grayscale value and a target display frequency that correspond to the target pixel point, wherein the target grayscale value is greater than the grayscale value of the target pixel point, and the target display frequency is less than or equal to a first design display frequency of the target pixel point; and
displaying, based on the target grayscale value and the target display frequency, the target pixel point in the image.

2. The method according to claim 1, wherein the obtaining, based on the preset correspondence, the target grayscale value and the target display frequency that correspond to the target pixel point comprises:
determining, based on the preset correspondence, the target grayscale value and the target display frequency that correspond to the grayscale value of the target pixel point.

3. The method according to claim 1, further comprising:
determining a low grayscale range;
assigning a target grayscale value to each grayscale value within the low grayscale range;
determining, based on a first design display frequency of a pixel point with a grayscale value within the low grayscale range, a target display frequency corresponding to the target grayscale value assigned to the grayscale value; and
establishing the correspondence by associating the each grayscale value within the low grayscale range with the target grayscale value and the target display frequency that correspond to the grayscale value.

4. The method according to claim 3, wherein target grayscale values corresponding to respective ones of grayscale values within the low grayscale range are at least partially the same; or
target grayscale values corresponding to respective ones of grayscale values within the low grayscale range are mutually different.

5. The method according to claim 1, wherein the display panel is provided with 256 grayscales, and the grayscale threshold is less than or equal to 8.

6. The method according to claim 5, wherein an absolute value of a difference between the grayscale value of the target pixel point and the target grayscale value corresponding to the target pixel point is greater than or equal to 4, and is less than or equal to 10.

7. The method according to claim 1, wherein the first design display frequency of the target pixel point is 2 to 4 times the target display frequency.

8. The method according to claim 1, wherein a display frequency of a pixel point, in the image to be displayed, with a grayscale value greater than the grayscale threshold is a second design display frequency;
the first design display frequency of the target pixel point is the same as the second design display frequency; or
the first design display frequency of the target pixel point is greater than the second design display frequency.

9. The method according to claim 8, wherein before the displaying, based on the target grayscale value and the target display frequency, the target pixel point in the image, the method further comprises:
determining, based on the target grayscale value, a grayscale voltage corresponding to the target grayscale value.

10. The method according to claim 9, wherein the displaying, based on the target grayscale value and the target display frequency, the target pixel point in the image comprises:
displaying, according to the target display frequency, the target pixel point in the image by using the grayscale voltage corresponding to the target grayscale value.

11. The method according to claim 8, further comprising:
determining a grayscale voltage of each pixel point, in the image to be displayed, with a grayscale value greater than the grayscale threshold; and
displaying, according to the second design display frequency, the pixel point, in the image, with the grayscale value greater than the grayscale threshold by using the grayscale voltage of the each pixel point.

12. The method according to claim 8, wherein the first design display frequency of the target pixel point is greater than or equal to 120 Hz.

13. The method according to claim 9, wherein the grayscale voltage of the target grayscale value is greater than a grayscale voltage of a low grayscale value corresponding to the target grayscale value.

14. (canceled)

15. A computer-readable storage medium, storing a computer program, wherein the program, when executed by a processor, implements a driving method for a display panel, wherein the method comprises:
obtaining a grayscale value of each pixel point in an image to be displayed;
determining a pixel point as a target pixel point in response to the grayscale value of the pixel point being less than a preset grayscale threshold;
obtaining, based on a preset correspondence, a target grayscale value and a target display frequency that correspond to the target pixel point, wherein the target grayscale value is greater than the grayscale value of the target pixel point, and the target display frequency is less than or equal to a first design display frequency of the target pixel point; and
displaying, based on the target grayscale value and the target display frequency, the target pixel point in the image.

16. A display apparatus, comprising:
a display panel;
one or more processors; and
a storage device, configured to store one or more programs, wherein the one or more processors, through executing the one or more programs, are configured to:
obtain a grayscale value of each pixel point in an image to be displayed;
determine a pixel point as a target pixel point in response to the grayscale value of the pixel point being less than a preset grayscale threshold;
obtain, based on a preset correspondence, a target grayscale value and a target display frequency that correspond to the target pixel point, wherein the target grayscale value is greater than the grayscale value of the target pixel point, and the target display frequency is less than or equal to a first design display frequency of the target pixel point; and
display, based on the target grayscale value and the target display frequency, the target pixel point in the image.

17. The apparatus according to claim 16, wherein the one or more processors are specifically configured to:
determine, based on the preset correspondence, the target grayscale value and the target display frequency that correspond to the grayscale value of the target pixel point.

18. The apparatus according to claim 16, wherein the one or more processors are further configured to:
determine a low grayscale range;
assign a target grayscale value to each grayscale value within the low grayscale range;
determine, based on a first design display frequency of a pixel point with a grayscale value within the low grayscale range, a target display frequency corresponding to the target grayscale value assigned to the grayscale value; and
establish the correspondence by associating the each grayscale value within the low grayscale range with the target grayscale value and the target display frequency that correspond to the grayscale value.

19. The apparatus according to claim 18, wherein target grayscale values corresponding to respective ones of grayscale values within the low grayscale range are at least partially the same; or
target grayscale values corresponding to respective ones of grayscale values within the low grayscale range are mutually different.

20. The apparatus according to claim 16, wherein the display panel is provided with 256 grayscales, and the grayscale threshold is less than or equal to 8.

21. The apparatus according to claim 20, wherein an absolute value of a difference between the grayscale value of the target pixel point and the target grayscale value corresponding to the target pixel point is greater than or equal to 4, and is less than or equal to 10.
